(19) United States
(12) Patent Application Publication
(10) Pub. No.: US 2008/0026213 A1
(43) Pub. Date: Jan. 31, 2008

(54) Sticker Supporting Member for a Wall Surface

(76) Inventor: Yung-Huei Lan, Taipei (CN)

Correspondence Address: BACON & THOMAS, PLLC, 625 SLATERS LANE, FOURTH FLOOR, ALEXANDRIA, VA, 22314, US

(21) Appl. No.: 11/579,502

(22) PCT Filed: Mar. 14, 2006
(86) PCT No.: PCT/CN06/00393

§ 371 Date: Nov. 3, 2006

(30) Foreign Application Priority Data
Mar. 16, 2005 (CN) 200520008575.4

(51) Int. Cl. B32B 7/12; A47G 29/00

(52) U.S. Cl. 428/344; 428/343

(57) ABSTRACT

A sticker supporting member for a wall includes a base, adhesive member, and a supporting member. The supporting member is connected with the base. The adhesive member is a sticker having well effects on sealing the air and can be stuck on the smooth wall tightly. The adhesive member is stuck with the base and has a surface outward extended beyond the edges of the base. The characteristic is that a cross section of the side face of the base and the surface of the adhesive member is a transitional face extended from the edges of the base to the outer circumference of the adhesive member. The supporting member can easily squeeze out the air between the sticker and the base. The metal layer in the base can prevent the air permeating between the sticker and the wall to avoid peeling. The present invention can be widely applied in living.

### FIELD OF THE INVENTION

The present invention relates to a living accessory and particularly a sticker supporting member for a wall surface.

### BACKGROUND OF THE INVENTION

In daily livings, the supporting members for wall surfaces in general are used for supporting the cloth or hat hangers, soap racks, towel rods in the bathroom and so on. China patent publication no. CN2459993Y disclosed a sticker supporting member for a wall surface including a base, a sticker, and a supporting member. The supporting member has a suitable frame shape and is connected with the base. The sticker has well effects on sealing the air and can be stuck on the wall tightly. The sticker is connected with the base and has a surface outward extended beyond the edges of the base. Since the sticker and the wall are stuck together, the contact area of the sticker and the wall is larger than the back area of the base, and the sticker stuck on the wall has well effects on sealing air, it is very convenient that the sticker supporting member for a wall surface can be fixed on the wall tightly and for a long time. When in use, in order to fix the sticker supporting member for a wall surface on the wall tightly, it is necessary to squeeze out the air of the adherent location of the sticker when adhesion. At the same time, the user has to prevent the air entrance between the sticker and the wall as much as possible. However, in the cross section of the base and the sticker, the surface of the sticker and the side surface of the base are almost forming a right angle and a cross line of the conventional sticker supporting member for a wall surface. User's fingers can not reach the position around the cross line so that there is a dead corner incurred. Since the fingers can not press the stick around the cross section of the base, the air bubble under the stick can not be squeezed out. Moreover, the air will pass through the base and get into between the stick and wall such that the vacuum between the sticker and the wall surface become less and the adhesion is influenced.

### SUMMARY OF THE INVENTION

The present invention aims to solve the defects mentioned above and provides an improved sticker supporting member for a wall which can easily squeeze out the air when adhesion and prevent the air from passing through the base and getting into between the sticker and the wall surface. Thus, the condition of vacuum becoming less can be postponed and the adhesion time can be extended.

The present invention provides the following technology:

A sticker supporting member for a wall includes a base, adhesive member, and a supporting member. The supporting member is connected with the base. The adhesive member is a sticker having well effects on sealing the air and can be stuck on the smooth wall tightly. The adhesive member is stuck with the base and has a surface outward extended beyond the edges of the base. The characteristic of the present invention is that a cross section of the side face of the base and the surface of the adhesive member is a transitional face extended from the edges of the base to the outer circumference of the adhesive member.

The transitional face is the face connecting to the surface of the base and the surface of the adhesive member when fingers move from the surface of the base to the surface of the adhesive member, fingers can slip through the face without interspaces. Also, when fingers touch the base and the sticker, there is no dead corner in the cross section of the base and the sticker. When the fingers move from the edges of the base to the outer circumference of the sticker to squeeze the air, the air between the sticker and the base will be squeezed out continuously from the edges of the base to the edges of the sticker on an inclined plane or a cambered plane.

The base has metal layers to prevent the air molecule permeating. The metal layers include an inner metal layer and an outer metal layer. These two metal layers are separated from each other or have a weak connection structure.

The supporting member includes a hanger, an insert trough, and an insert seat. The hanger has a fastening structure for clamping with a plug in device. The fastening structure is a sharp protrusion located on the exterior side of the hanger.

The surface of the base or the base with the sticker is sprayed an air isolated layer for preventing the air permeating.

An upper position of the base has a thread structure for connecting with other objects.

The sticker supporting member for a wall further has a friction plate which is pressed on the surface of the base and generates an upward striction to countervail the gravity of the heavy object along the erective direction. The friction plate is directly wedged on the supporting member, connected with the base, or passes a screw and connects with a thread hole on the metal layer in the base.

The metal layer in the base is parallel to a bottom face of the base.

The middle of the bottom face of the base has a cave with a slight range under the free condition.

The metal layer has elasticity. The inner metal layer is a cambered surface outward projecting.

Some part of the metal layer of the base can extend out of the base and directly form a hook shape or any other supporting member shape.

The surface of the base or the base with the sticker is sprayed an air isolated layer for preventing the air permeating. A spray of the air isolated layer can be a metal spray or fluid glass.

The sticker supporting member for a wall can easily discharge the air between the sticker and the wall completely by the transitional face extended from the edges of the base to the outer circumference of the adhesive member. There is no air remaining. The metal layer in the base can prevent the air gradually passing through the base and permeating between the sticker and the wall so that the peeling incurred because of the air permeating after a long time can be avoided. Further, since the metal layers include the inner metal layer and the outer metal layer, when the metal layer receives the pulling force, the inner metal layer will move outward but the outer layer is still. Thus, a space is formed between the sticker and the wall for containing air. The reduction of the vacuum between the sticker and the wall can be slow down. Besides, the surface of the base or the base with the sticker is sprayed an air isolated layer for preventing the air permeating. Thus, it is more effective to prevent the air permeating and prolong the adhesive time.

The present invention can connect with other objects by a thread on the upper position of the base or installing the hanger, the insert trough, and the insert seat. By cooperating with other objects, the present invention can have more purposes and functions and enhance the practicability.

The present invention can be applied to the walls of bathrooms, kitchens, bedrooms, living rooms, refrigerators and wardrobes. It is convenient to attach, firm, and easily to exchange.

### BRIEF DESCRIPTION OF THE DRAWINGS

FIG. 1 is a whole structure view of a first preferred embodiment of the present invention.

FIG. 2 is a top view of the first preferred embodiment of the present invention.

FIG. 3 is a left view of the first preferred embodiment of the present invention.

FIG. 4 is a right view of the first preferred embodiment of the present invention.

FIG. 5 is a cross-sectional view of a metal layer of the first preferred embodiment of the present invention.

FIG. 6 is a cross-sectional view of structure variation when the metal layer of FIG. 5 receives the pulling force along the arrow direction.

FIG. 7 is a cross-sectional view of the metal layer of the first preferred embodiment formed an outward protruding cambered surface shape structure.

FIG. 8 is a cross-sectional view of structure variation when the metal layer of FIG. 7 receives the pulling force along the arrow direction.

FIG. 9 is a cross-sectional view of structure variation when the metal layer of FIG. 7 receives the stress along the arrow direction.

FIG. 10 is a whole structure view of a second preferred embodiment of the present invention.

FIG. 11 is a cross-sectional view in the A-A position of FIG. 10 and shows a structure of a friction plate and the metal layer of second preferred embodiment of the present invention.

FIG. 12 is a cross-sectional view of structure variation when the metal layer of FIG. 11 receives the pulling force along the arrow direction.

FIG. 13 is a cross-sectional view of the structure of the metal layer formed an outward protruding cambered surface shape and the friction plate of the second preferred embodiment.

FIG. 14 is a cross-sectional view of structure variation when the metal layer of FIG. 13 receives the pulling force along the arrow direction.

FIG. 15 is a cross-sectional view of structure variation when the metal layer of FIG. 13 receives the stress along the arrow direction.

FIGS. 16a and 16b are perspective views of the first preferred embodiment in FIG. 1 for additionally hanging on a soap case.

FIGS. 17a and 17b are perspective views of the first preferred embodiment in FIG. 1 for additionally hanging on a liquid soap bottle.

FIGS. 18a and 18b are perspective views of the first preferred embodiment in FIG. 1 for additionally hanging on a hanger.

### DETAILED DESCRIPTION OF THE PREFERRED EMBODIMENTS

The present invention is further described with the drawings and the embodiments of the drawings.

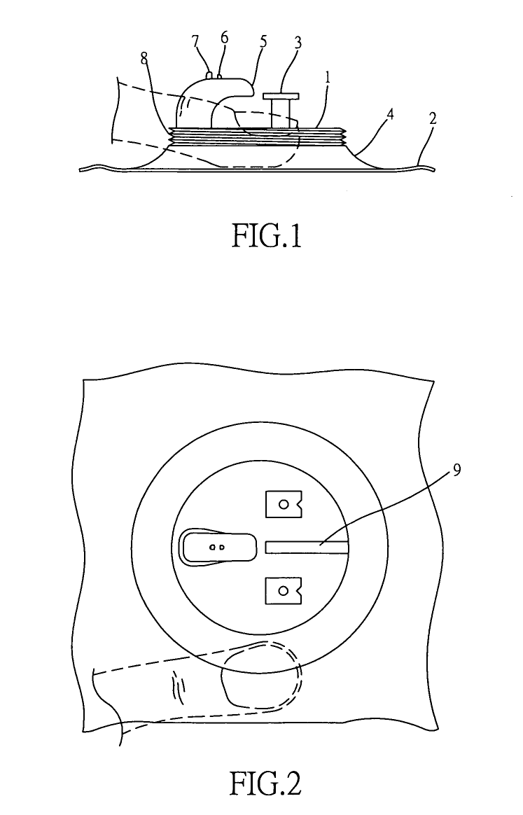

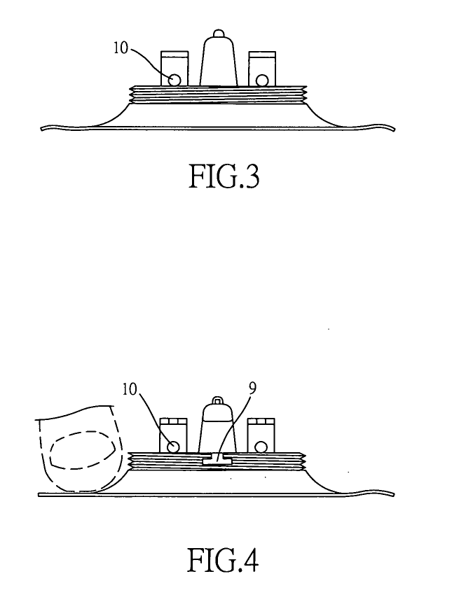

FIGS. 1 to 4 illustrate a preferred embodiment for the present invention. In this preferred embodiment, the sticker supporting member of a wall includes a base, an adhesive member and a supporting member. The base is made of PVC material. The adhesive member has good air sealing function and is a sticker 2 which can stick with smooth walls tightly. The supporting member is a hanger 5. The sticker 2 can stick with the base 1. The surface of the sticker is over the edges of the base 1 and outward extended. The characteristic of the present invention is that a cross section of the side face of the base 1 and the surface of the sticker 2 is a transitional face 4 extended from the edges of the base to the outer circumference of the sticker 2. In this preferred embodiment, the transitional face 4 is a cambered surface and the surface of the transitional face 4 is slightly rough. Thus, during the adhesion, the appearance can be maintained because it is not easy to be found that there is glue flowing over. The transitional face 4 is suitable for fingers slipping through without interspaces. When fingers touch the base 1 and the sticker 2, there is no dead corner in the cross section of the base 1 and the sticker 2. When the fingers move from the edges of the base 1 to the outer circumference of the sticker 2 to squeeze the air, the air between the sticker 2 and the base 1 will be squeezed out continuously from the edges of the base 1 to the edges of the sticker 2. There is no air bubble between the sticker 2 and the wall surface when adhesion because the sticker 2 and the wall surface can be tightly and firmly closed up. The sticker supporting member of a wall can fix on the wall or glass for a long time without the peeling incurred.

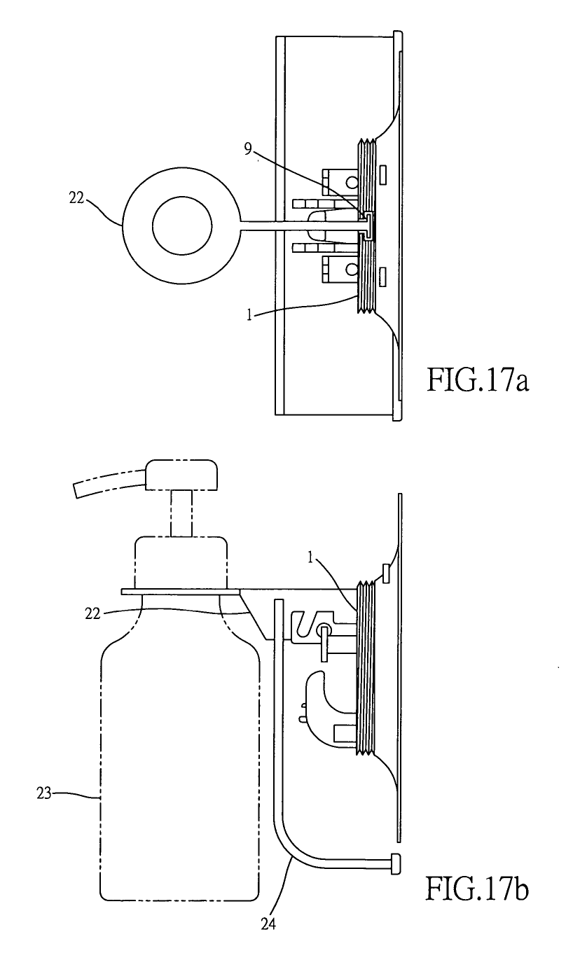

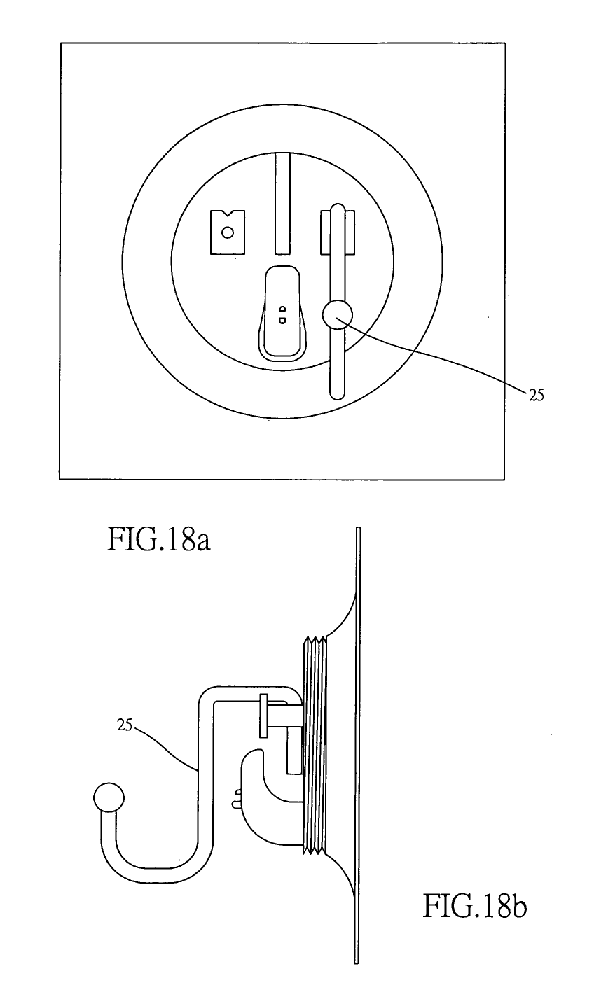

The base 1 of this preferred embodiment further has an outer thread 8 on the upper position such that the base 1 can operate with other objects which have inner thread correspondingly. Thus, the function of the present invention will become more and the present invention can directly hold the heavy objects which have threads outside their surfaces. The supporting member of this preferred embodiment can have various structures according to the needs of the hang-on devices and enlarges the use range of the sticker supporting member for a wall. In this preferred embodiment, the supporting member includes the hanger 5, an insert seat 3 and an insert trough 9. The hanger 5 has a fastening structure to wedge with the plug in device. The fastening structure can be a sharp protruding 6 on the outside of the hanger 5. Under the sharp protruding 6, there is a block 7 with an even and smooth surface to prevent fingers from scratching. The insert seat 3 has a hole 10 for receiving the hanger (as shown in FIGS. 18a and 18b). The insert trough 9 is installed on the surface of the base. The object having the plug can insert into the insert trough 9 (as shown in FIGS. 17a and 17b).

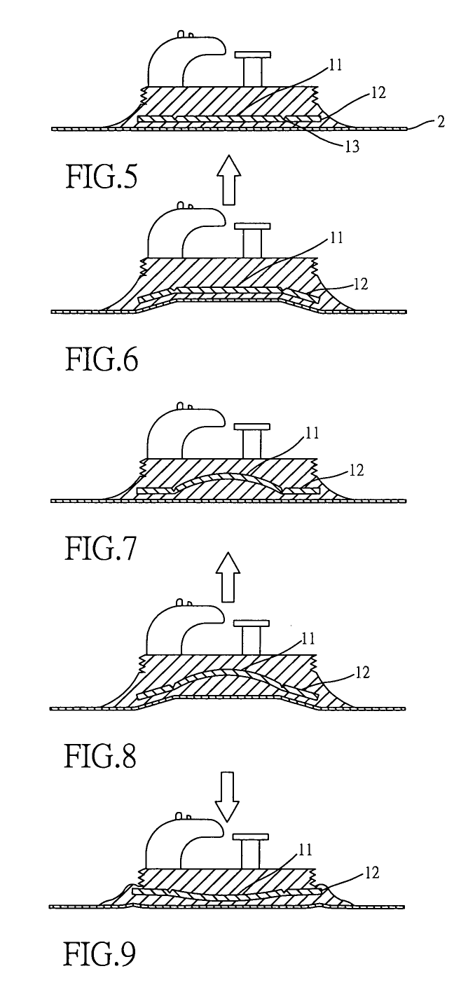

Please refer to FIGS. 5 to 9. The base 1 of the present invention has metal layers for buffering the vacuum. The metal layers are parallel to the bottom of the base 1 and include an inner metal layer 11 and an outer metal layer 12. These two metal layers 11, 12 can be separated from each other and divided into two portions or have a weak connection structure 13 between them for forming a cushion space when they suffer from the press. As shown in FIG. 6. When the metal layer receives the pulling force along the arrow direction which is vertical to the metal plane, the inner metal layer 11 will move inward more but the outer metal layer 12 will move outward less. The space formed between the sticker 2 and the wall for containing the air will make the vacuum between them decrease slowly. As shown in FIG. 7, the metal layer is a cambered surface structure outward projecting. The metal layer is a steel piece with elasticity. As shown in FIG. 8, When the metal layer receives the pulling force along the arrow direction which is vertical to the metal plane, the cambered surface can release the rapid variation of the receiving force between the sticker 2 and the wall. Also, the vacuum between them will decrease slowly. When taking off the sticker 2, providing the press to the base 1 along the arrow direction as shown in FIG. 9, the metal layer receives the inward press vertical to the metal plane, the inner metal layer 11 will move inward. Since the steel piece has elasticity, the metal layer will change shape or tilt such that the base 1 and the sticker 2 can be easily separated from the wall. The middle portion of the bottom of the base 1 has a cave with a slight range under the free condition as shown in FIG. 7. For the wall having adhesive resistance to the sticker 2, press the middle portion of the base 1 to the wall when adhesion, the bottom of the base 2 will be pressed to be even. In the meanwhile, press the peripheral sticker to attach the wall. When the hand moves off, a little of vacuum between the middle portion of the base 1 and the wall is formed because of the resilience of the base 1. The sticker 2 attached to the wall around the base 1 is also effected by the vacuum and thus sticks on the wall more tightly. The present invention can prevent peeling when there is no force. When the present invention receives the force to separate from the wall, larger vacuum will be formed between the base 1 and the wall, and thus can prevent peeling more effectively.

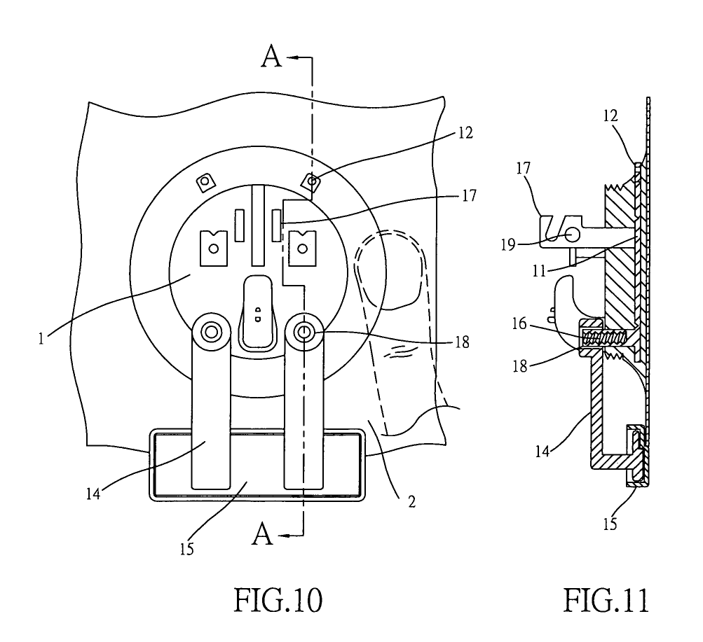

FIGS. 10 and 11 show the second preferred embodiment of the present invention. The difference from the first preferred embodiment is to further have a friction plate 14. The friction plate 14 can connect with the base 1 or a rod extended from the metal layer of the base 1 through the thread. In this preferred embodiment, the friction plate 14 connects with a thread rod 18 extended from the metal layer of the base 1 through a thread hole 16. A seat 15 of the friction plate 14 can directly press to the wall. When the supporting member is under the load-bearing condition, the friction plate 14 passing through the seat 15 will suffer the force which is pressed to the wall. An upward striction is generated to countervail the gravity of the heavy object along the erective direction to cause the supporting effect. Another difference is that some part of the outer metal layer 12 of the base 1 can extend out of the base 1 and directly form a hook shape or any other supporting member shape. Also, the extended part can be used as a firm foundation or stand. A hole installed on it can securely couple with the supported object. The inner metal layer 11 can directly pass through PVC materials to form an extended hanger 17. The extended hanger 17 has a hook and an aperture 19 to hang up heavier objects.

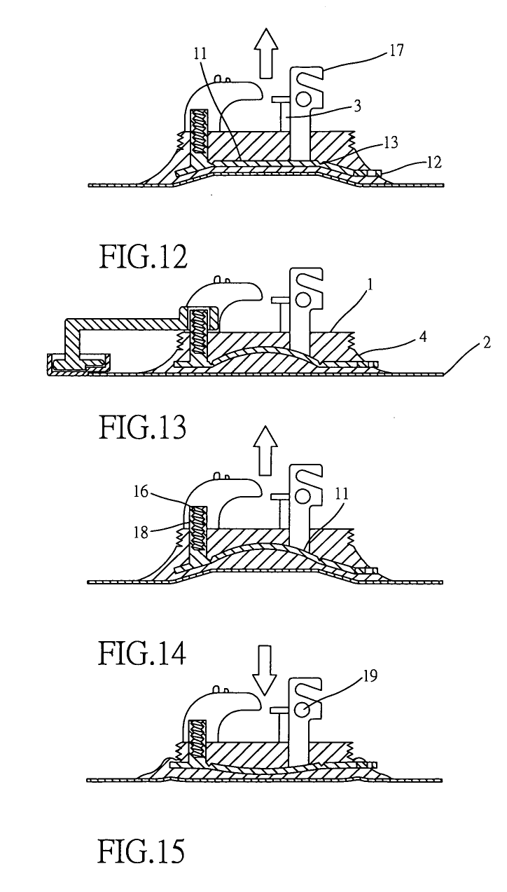

Please refer to FIGS. 12 to 15. FIG. 12 is a cross-sectional view of the metal layer of the second preferred embodiment. The metal layers in the base 1 include the inner metal layer 11 and the outer metal layer 12. The metal layers are parallel to the bottom of the base 1. The weak connection structure 13 is installed between the inner metal layer 11 and the outer metal layer 12. In FIG. 13, the metal layer is a cambered surface structure outward projecting. The metal layer is a steel piece with elasticity. When receiving the force as shown in FIG. 14 and FIG. 15, the variation condition is the same as the first preferred embodiment. Thus, the detail is omitted. The middle of the bottom face of the base has the cave with a slight range under the free condition as shown in FIG. 13. The detail is also omitted because of the same work principle.

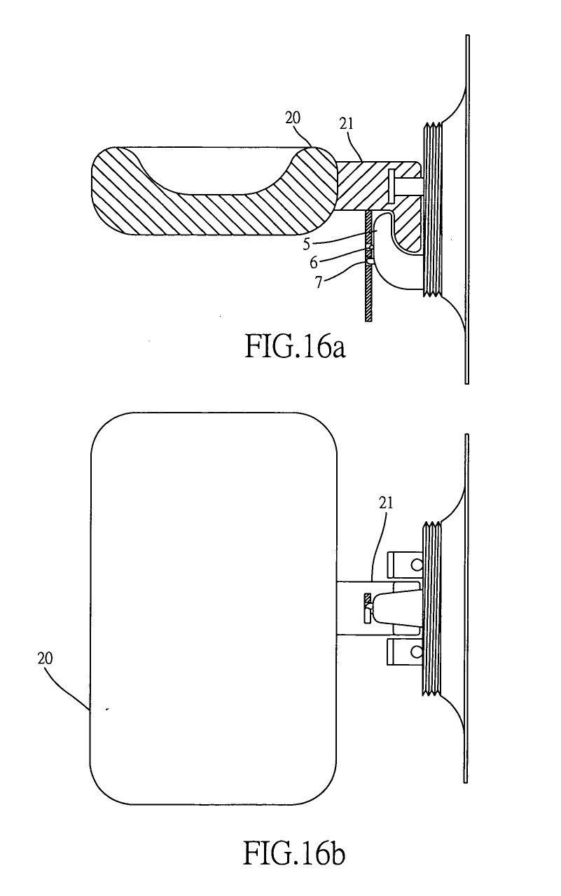

FIGS. 16a and 16b are perspective views of the first preferred embodiment in FIG. 1 for additionally hanging on a soap case. FIG. 16a is the main view of the structure and FIG. 16b is the top view of the structure. A soap bracket 21 is wedged in the base 1 by the hanger 5, the sharp protruding 6 and the block 7. It is very convenient that a soap case 20 can be put above it.

FIGS. 17a and 17b are perspective views of the first preferred embodiment in FIG. 1 for additionally hanging on a liquid soap bottle. FIG. 17a is the main view of the structure and FIG. 17b is the top view of the structure. A ring bracket 22 passes through the hook and is fixed on the base 1. A liquid soap bottle 17 can be put within a ring of the ring bracket 22. A supporting rack 24 of the ring bracket 22 has a hold to support the wall such as the function of the friction plate 14. The detail is omitted.

FIGS. 18a and 18b are perspective views of the first preferred embodiment in FIG. 1 for additionally hanging on a hanger. FIG. 18a is the main view of the structure and FIG. 18b is the top view of the structure. An additional hanger 25 is fixed on the base 1 by the hole 10. Towels or small objects can be hung on as well. The additional hanger 25 can be taken off to store if it is no need.

The surface of the base 1 or the base 1 with the sticker 2 can be sprayed an air isolated layer for preventing the air permeating. A spray of the air isolated layer can be a metal spray or fluid glass to further prevent from the air permeating and enhance the reliability of the sticker supporting member of a wall.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

1. A sticker supporting member for a wall surface comprises a base, an adhesive member and a supporting member, the supporting member being connected with the base, the adhesive member being a sticker having well effect on sealing air and being able to be stuck on the smooth wall tightly, and the adhesive member being stuck with the base and having a surface outward extended beyond the edges of the base, wherein a cross section of the side face of the base and the surface of the adhesive member is a transitional face extended from the edges of the base to the outer circumference of the adhesive member.

2. The sticker supporting member of claim 1, wherein the transitional face is an inclined plane or a cambered plane connecting to the surface of the base and the surface of the adhesive member, and is suitable for fingers slipping through the face without interspaces so that when the fingers move from the edges of the base to the outer circumference of the sticker to squeeze the air, the air between the sticker and the base will be squeezed out continuously from the edges of the base to the edges of the sticker.

3. The sticker supporting member of claim 1, wherein the base has metal layers to prevent the air molecule permeating.

4. The sticker supporting member of claim 3, wherein the metal layers include an inner metal layer and an outer metal layer, and two metal layers are separated from each other or have a weak connection structure.

5. The sticker supporting member of claim 4, wherein the metal layer is a metal piece with elasticity and the inner metal layer is a cambered surface outward projecting.

6. The sticker supporting member of claim 1, wherein the supporting member further includes a hanger, an insert trough, and an insert seat, the hanger has a fastening structure for clamping with a plug in device and the fastening structure is a sharp protrusion located on the exterior side of the hanger.

7. The sticker supporting member of claim 1, wherein the surface of the base or the base with the sticker is sprayed an air isolated layer for preventing air permeating.

8. The sticker supporting member of claim 1, wherein an upper position of the base has a thread structure for connecting with other objects.

9. The sticker supporting member of claim 1, wherein the sticker supporting member for a wall further has a friction plate which is pressed on the surface of the base and generates an upward striction to countervail the gravity of the heavy object along the erective direction, and the friction plate is directly wedged on the supporting member, is connected with the base, or passes a screw and connects with a thread hole on the metal layer in the base.

10. The sticker supporting member of claim 1, wherein the metal layer in the base is parallel to a bottom face of the base.

11. The sticker supporting member of claim 1, wherein the middle of the bottom face of the base has a cave with a slight range under the free condition.

12. The sticker supporting member of claim 3, wherein some part of the metal layer of the base can extend out of the base and directly form a hook shape or any other supporting member shape.

13. The sticker supporting member of claim 8, wherein some part of the metal layer of the base can extend out of the base and directly form a hook shape or any other supporting member shape.

14. The sticker supporting member of claim 9, wherein some part of the metal layer of the base can extend out of the base and directly form a hook shape or any other supporting member shape.
